(19) United States
(12) Patent Application Publication
(10) Pub. No.: US 2021/0140223 A1
(43) Pub. Date: May 13, 2021

(54) DOOR SYSTEM

(71) Applicant: Fox Aluminum Products, Inc., Hazel Park, MI (US)

(72) Inventor: James Emery Fox, Lexington, MI (US)

(21) Appl. No.: 16/676,577

(22) Filed: Nov. 7, 2019

(51) Int. Cl. E06B 1/14; E06B 1/70; E06B 1/52

(52) U.S. Cl. CPC E06B 1/14; E06B 1/52; E06B 1/70

(57) ABSTRACT

A door system has a door jamb assembly with first and second aluminum side jambs, an aluminum head jamb, and an aluminum sill assembly. The first aluminum side jamb encapsulates a first portion of a previously installed first side jamb. The first aluminum side jamb has a screw boss extending from the top end to the bottom end thereof. The second aluminum side jamb encapsulates a first portion of a previously installed second side jamb. The second aluminum side jamb has a screw boss extending from the top end to the bottom end thereof. The aluminum head jamb extends between the top end of the first aluminum side jamb and the top end of the second aluminum side jamb. The aluminum sill assembly extends between the bottom end of the first aluminum side jamb and the bottom end of the second aluminum side jamb.

### BACKGROUND

Steel entry door frames have two steel side jambs which typically rust out over time. Normally, the rust starts at the bottom of a steel side jamb and moves upwardly. In masonry construction, each steel side jamb is mortared in place and has steel ties extending into a constructed block wall. Further, a cavity inside each steel side jamb is filled with concrete to form a concrete support for holding the steel side jamb to the block wall.

A first problem with the steel entry door frames is that moisture causes each steel side jamb to rust out from the inside out. Further, when a person is able to view the external corrosion on a steel side jamb, the internal rust damage is well underway.

A second problem with steel entry door frames is that the removal and replacement of a steel entry door frame is costly, messy, and very expensive since it is labor intensive. Most of labor cost is for a contractor to remove the steel side jambs that are cemented to the block wall and to repair damage to the block wall during the removal of the steel entry door frame.

The inventor herein has recognized a need for an improved door system that encapsulates previously installed steel side jambs (without having to remove the previously installed steel side jambs) and that is rust resistant. Further, the inventor herein has recognized that it would be advantageous for the door system to have a door jamb assembly with first and second aluminum side jambs with first and second screw bosses that are used to easily and securely couple the first and second aluminum side jambs to an aluminum head jamb and an aluminum sill assembly.

### SUMMARY

A door system in accordance with an exemplary embodiment is provided. The door system includes a door jamb assembly having first and second aluminum side jambs, an aluminum head jamb, an aluminum sill assembly, and first, second, third and fourth screws. The first aluminum side jamb is sized and shaped to encapsulate a first portion of a previously installed first side jamb. The first aluminum side jamb has a top end, a bottom end, and a first screw boss extending from the top end to the bottom end thereof. The second aluminum side jamb is sized and shaped to encapsulate a first portion of a previously installed second side jamb. The second aluminum side jamb has a top end, a bottom end, and a first screw boss extending from the top end to the bottom end thereof. The aluminum head jamb extends between the top end of the first aluminum side jamb and the top end of the second aluminum side jamb. The first screw is disposed through the aluminum head jamb and within the first screw boss of the first aluminum side jamb to couple the aluminum head jamb to the first aluminum side jamb. The second screw is disposed through the aluminum head jamb and within the first screw boss of the second aluminum side jamb to couple the aluminum head jamb to the second aluminum side jamb. The aluminum sill assembly extends between the bottom end of the first aluminum side jamb and the bottom end of the second aluminum side jamb. The third screw is disposed through the aluminum sill assembly and within the first screw boss of the first aluminum side jamb to couple the aluminum sill assembly to the first aluminum side jamb. The fourth screw is disposed through the aluminum sill assembly and within the first screw boss of the second aluminum side jamb to couple the aluminum sill assembly to the second aluminum side jamb. The door system further includes a door rotatably coupled to the first aluminum side jamb.

### BRIEF DESCRIPTION OF THE DRAWINGS

FIG. 1 is a schematic of a portion of a building having a door system and building walls in accordance with an exemplary embodiment;

FIG. 2 is another schematic of a portion of the building having the door system of FIG. 1;

FIG. 3 is another schematic of a portion of the building having the door system of FIG. 1;

FIG. 4 is an exploded view of the door system of FIG. 1;

FIG. 5 is a top view of the door system and the building walls of FIG. 1;

FIG. 6 is a cross-sectional view of the door system of FIG. 1;

FIG. 7 is an enlarged top view of a left portion of the door system and the building walls of FIG. 1;

FIG. 8 is an enlarged cross-sectional view of a left portion of the door system and the building walls of FIG. 1;

FIG. 9 is an enlarged top view of a right portion of the door system and the building walls of FIG. 1;

FIG. 10 is an enlarged cross-sectional view of a right portion of the door system and the building walls of FIG. 1;

FIG. 11 is an enlarged view of a right portion of the door system and the building walls of FIG. 1;

FIG. 12 is a cross-sectional view of a top portion of the door system of FIG. 1;

FIG. 13 is a cross-sectional view of a bottom portion of the door system of FIG. 1;

FIG. 14 is a cross-sectional view of another bottom portion of the door system of FIG. 1;

FIG. 15 is a top view of a first aluminum side jamb, a hinge member, and a door utilized in the door system of FIG. 1;

FIG. 16 is a schematic of a first aluminum side jamb utilized in the door system of FIG. 1;

FIG. 17 is a cross-sectional schematic of the first aluminum side jamb of FIG. 16;

FIG. 18 is a schematic of a second aluminum side jamb utilized in the door system of FIG. 1;

FIG. 19 is a cross-sectional schematic of the second aluminum side jamb of FIG. 18;

FIG. 20 is a schematic of a hinge member utilized in the door system of FIG. 1;

FIG. 21 is a schematic of an aluminum head jamb utilized in the door system of FIG. 1;

FIG. 22 is a cross-sectional schematic of the aluminum head jamb of FIG. 21;

FIG. 23 is a cross-sectional schematic of a trim member utilized in the door system of FIG. 1; and

FIG. 24 is a cross-sectional exploded schematic of an aluminum sill assembly utilized in the door system of FIG. 1.

### DETAILED DESCRIPTION

Referring to FIGS. 1-4, a portion of a building 20 is illustrated. The building 20 includes building walls 30, 40, concrete supports 50, 60, previously installed steel side jambs 70, 80, and an inventive door system 90 in accordance with an exemplary embodiment.

Referring to FIG. 5, the concrete supports 50, 60 are attached to the building walls 30, 40, respectively. The concrete supports 50, 60 are coupled to and support the previously installed steel side jambs 70, 80, respectively. The inventive door system 90 encapsulates and is coupled to the previously installed steel side jambs 70, 80 as will be discussed in greater detail below.

Referring to FIGS. 4, 8 and 10, the door system 90 includes a doorjamb assembly 200, a door 210, hinge members 220, 222, 224, screws 240, 242, 244, 246, 248, 250, 260, 262, 264, 270, 272, 274.

Referring to FIGS. 4, 5, 7, 8, 10, 13 and 14 the doorjamb assembly 200 includes a first aluminum side jamb 300 (shown in FIGS. 7 and 8), a first aluminum trim portion 305, a second aluminum side jam 310 (shown in FIG. 10), a second aluminum trim portion 315, an aluminum head jamb 320 (shown in FIGS. 4 and 5), an aluminum sill assembly 330 (shown in FIGS. 4 and 5), and screws 340, 342, 344, 346, 348, 350, 352, 354.

Referring to FIGS. 8, 15, 16 and 17, the first aluminum side jamb 300 is sized and shaped to encapsulate a first portion of a previously installed first steel side jamb 70 and to hold the hinge members 220, 224, 226 (shown in FIG. 4) thereon. The first aluminum side jamb 300 includes a Z-shaped member 400 (shown in FIG. 15) and a weather-strip member 402 (shown in FIG. 8).

Referring to FIG. 15, the Z-shaped member 400 includes a first side wall 410, a second side wall 412, a third side wall 414, an arcuate-shaped hinge receiving portion 416, a first tab portion 418, a second tab portion 420, a third tab portion 422, a fourth tab portion 424, a first screw boss 430, a second screw boss 432, a top end 434 (shown in FIG. 4), and a bottom end 436. Referring to FIG. 4, the Z-shaped member 400 further includes cut-out portions 460, 462, 464 in the arcuate-shaped hinge receiving portion 416 to receive the hinge members 220, 224, 226, respectively, therein.

Referring to FIG. 15, the first and second tab portions 418, 420 extend from the first wall 410 in a first direction.

The arcuate-shaped hinge receiving portion 416 is coupled between the first and second walls 410, 412, and, the first and second walls 410, 412 extend perpendicular to one another. The arcuate-shaped hinge receiving portion 416 is configured to rotatably receive a post from the hinge member 220 (shown in FIG. 4) therein.

Referring to FIGS. 4 and 15, the first and second screw bosses 430, 432 are coupled to the second wall 412. The first screw boss 430 extends from the top end 434 to the bottom end 436 of the Z-shaped member 400. The second screw boss 432 extends from the top end 434 to the bottom end 436 of the Z-shaped member 400 and extends parallel to the first screw boss 430. In an exemplary embodiment, the first and second screw bosses 430, 432 are each C-shaped with an internal diameter less than an outer diameter of an associated screw.

The third wall 414 extends from the second wall 412 in a second direction perpendicular to the second wall 412 and opposite to the first direction of the first wall 410. The third wall 414 includes a groove 450 (shown in FIG. 17) that is configured to hold the weather-strip member 402 (shown in FIG. 8) therein. The weather-strip member 402 is provided to abut against the door 210 when the door 210 has a closed operational position.

The third and fourth tabs 422, 424 are coupled to extend away from the third wall 414 in the first direction and are parallel to the first and second tabs 418, 420.

Referring to FIGS. 8 and 15, during installation of the door jamb assembly 200, the first and second tabs 418, 420 abut against an outer surface of the previously installed steel side jamb 70. Further, the screw 260 is disposed through the first wall 410 and through the steel side jamb 70 to couple the Z-shaped member 400 to the steel side jamb 70. Further, the screw 262 is disposed through the fourth tab portion 424, the first aluminum trim portion 305, the third tab portion 422, and the steel side jamb 70 to couple the Z-shaped member 400 of the first aluminum side jamb 300 to the steel side jamb 70.

Referring FIGS. 4 and 8, still further during installation of the door jamb assembly 200, the screw 340 is disposed through the aluminum head jamb 320 and within the first screw boss 430 to couple the aluminum head jamb 320 to the Z-shaped member 400 of the first aluminum side jamb 300. Further, the screw 342 is disposed through the aluminum head jamb 320 and within the second screw boss 432 to couple the aluminum head jamb 320 to the Z-shaped member 400 of the first aluminum side jamb 300.

Referring FIGS. 4 and 13, still further during installation of the door jamb assembly 200, the screw 348 is disposed through a threshold member 702 of the aluminum sill assembly 330 and within the first screw boss 430 to couple the aluminum sill assembly 330 to the Z-shaped member 400 of the first aluminum side jamb 300. Further, the screw 350 is disposed through the threshold member 702 of the aluminum sill assembly 330 and within the second screw boss 432 to couple the aluminum sill assembly 330 to the Z-shaped member 400 of the first aluminum side jamb 300.

Referring to FIGS. 8 and 23, the first aluminum trim portion 305 is coupled to the first aluminum side jamb 300 and is sized and shaped to encapsulate a second portion of the previously installed first steel side jamb 70. The first aluminum trim portion 305 includes a first wall 440, a second wall 442, a third wall 444, a fourth wall 446, a first tab portion 448, and a second tab portion 450. The first wall 440 and the third wall 444 extend parallel to one another. The second wall 442 extends between and perpendicular to the first and third walls 440, 444 and is coupled to the first and third walls 440, 444. The third wall 444 extends between and is perpendicular to the second and fourth walls 442, 446 and is coupled to the second and fourth walls 442, 446. The first and second tab portions 448, 450 are coupled to and extend outwardly from the fourth wall 446 in a direction parallel to the third side wall 444.

Referring to FIGS. 8 and 15, during installation of the first aluminum trim portion 305, the first and second tab portions 448, 450 are disposed on the exterior surface of the previously installed steel side jamb 70. Further, a portion of the first wall 440 is disposed between the first and second tab portions 422, 424 of the Z-shaped member 400 of the first aluminum side jamb 300. The screw 264 is disposed through the fourth wall 446 and the steel side jamb 70 to couple the first aluminum trim portion 305 to the steel side jamb 70. Further, the screw 262 is disposed through the second tab portion 424, the first wall 440, the first tab portion 422, and the steel side jamb 70 to couple the first aluminum trim portion 305 to the steel side jamb 70.

Referring to FIGS. 10, 18 and 19, the second aluminum side jamb 310 is sized and shaped to encapsulate a first portion of a previously installed second steel side jamb 80. The second aluminum side jamb 310 includes a Z-shaped member 500 (shown in FIG. 19) and a weather-strip member 502 (shown in FIG. 10).

Referring to FIG. 19, the Z-shaped member 500 includes a first side wall 510, a second side wall 512, a third side wall 514, an arcuate-shaped hinge receiving portion 516, a first tab portion 518, a second tab portion 520, a third tab portion 522, a fourth tab portion 524, a first screw boss 530, a second screw boss 532, a top end 534 (shown in FIG. 4), and a bottom end 536.

The first and second tab portions 518, 520 extend from the first wall 510 in a first direction.

The arcuate-shaped hinge receiving portion 516 is coupled between the first and second walls 510, 512, and the first and second walls 510, 512 extend perpendicular to one another.

Referring to FIGS. 4 and 19, the first and second screw bosses 530, 532 are coupled to the second wall 512. The first screw boss 530 extends from the top end 534 to the bottom end 536 of the Z-shaped member 500. The second screw boss 532 extends from the top end 534 to the bottom end 536 of the Z-shaped member 500 and extends parallel to the first screw boss 530. In an exemplary embodiment, the first and second screw bosses 530, 532 are each C-shaped with an internal diameter less than an outer diameter of an associated screw.

The third wall 514 extends from the second wall 512 in a second direction perpendicular to the second wall 512 and opposite to the first direction of the first wall 510. The third wall 514 includes a groove 550 (shown in FIG. 19) that is configured to hold the weather-strip member 502 (shown in FIG. 10) therein. The weather strip member 502 is provided to abut against the door 210 when the door 210 has a closed operational position.

The third and fourth tabs 522, 524 are coupled to extend away from the third wall 514 in the first direction and are parallel to the first and second tabs 518, 520.

Referring to FIGS. 10 and 19, during installation of the door jamb assembly 200, the first and second tabs 518, 520 abut against an outer surface of the previously installed steel side jamb 90. Further, the screw 270 is disposed through the first wall 510 and through the steel side jamb 80 to couple the Z-shaped member 500 to the steel side jamb 80. Further, the screw 272 is disposed through the fourth tab portion 524, the second aluminum trim portion 315, the third tab portion 522, and the steel side jamb 80 to couple the Z-shaped member 500 of the second aluminum side jamb 310 to the steel side jamb 80.

Referring FIGS. 4 and 10, still further during installation of the door jamb assembly 200, the screw 344 is disposed through the aluminum head jamb 320 and within the first screw boss 530 to couple the aluminum head jamb 320 to the Z-shaped member 500 of the second aluminum side jamb 310. Further, the screw 346 is disposed through the aluminum head jamb 320 and within the second screw boss 532 to couple the aluminum head jamb 320 to the Z-shaped member 500 of the second aluminum side jamb 310.

Referring FIGS. 4 and 14, still further during installation of the door jamb assembly 200, the screw 352 is disposed through a threshold member 702 of the aluminum sill assembly 330 and within the first screw boss 530 to couple the aluminum sill assembly 330 to the Z-shaped member 500 of the second aluminum side jamb 310. Further, the screw 354 is disposed through the threshold member 702 of the aluminum sill assembly 330 and within the second screw boss 532 to couple the aluminum sill assembly 330 to the Z-shaped member 500 of the second aluminum side jamb 310.

Referring to FIG. 10, the second aluminum trim portion 315 is coupled to the second aluminum side jamb 310 and is sized and shaped to encapsulate a second portion of the previously installed second steel side jamb 80.

The second aluminum trim portion 315 includes a first wall 540, a second wall 542, a third wall 544, a fourth wall 546, a first tab portion 548, and a second tab portion 550. The first wall 540 and the third wall 544 extend parallel to one another. The second wall 542 extends between and is perpendicular to the first and third walls 540, 544 and is coupled to the first and third walls 540, 544. The third wall 544 extends between and is perpendicular to the second and fourth walls 542, 546 and is coupled to the second and fourth walls 542, 546. The first and second tab portions 548, 550 are coupled to and extend outwardly from the fourth wall 546 in a direction parallel to the third side wall 544.

Referring to FIGS. 10 and 19, during installation of the second aluminum trim portion 315, the first and second tab portions 548, 550 are disposed on the exterior surface of the previously installed steel side jamb 80. Further, a portion of the first wall 540 is disposed between the first and second tab portions 522, 524 of the Z-shaped member 500 of the second aluminum side jamb 310. The screw 274 is disposed through the fourth wall 546 and the steel side jamb 80 to couple the second aluminum trim portion 310 to the steel side jamb 80. Further, the screw 272 is disposed through the second tab portion 524, the first wall 540, the first tab portion 522, and the steel side jamb 80 to couple the second aluminum trim portion 315 to the steel side jamb 80.

Referring to FIGS. 4, 12, 21 and 22, the aluminum head jamb 320 is coupled to and extends between the top end 434 (shown in FIG. 4) of the first aluminum side jamb 300 and the top end 534 of the second aluminum side jamb 310. The aluminum head jamb 320 includes a bottom plate 600, a rain-guard member 602, a weather-strip retaining member 604, and the weather-strip member 606. The rain-guard member 602 is coupled to and extends upwardly from a first end of the bottom plate 600, and is provided to direct rain away from the door system 90. The weather-strip retaining member 604 is coupled to a second end of the bottom plate 600 and configured to hold the weather-strip member 606 therein. The weather-strip member 606 abuts against the door 210 when the door 210 has a closed operational position.

Referring FIGS. 4 and 8, as discussed above, the screw 340 is disposed through the aluminum head jamb 320 and within the first screw boss 430 to couple the aluminum head jamb 320 to the Z-shaped member 400 of the first aluminum side jamb 300. Further, the screw 342 is disposed through the aluminum head jamb 320 and within the second screw boss 432 to couple the aluminum head jamb 320 to the Z-shaped member 400 of the first aluminum side jamb 300

Referring FIGS. 4 and 10, as discussed above, the screw 344 is disposed through the aluminum head jamb 320 and within the first screw boss 530 to couple the aluminum head jamb 320 to the Z-shaped member 500 of the second aluminum side jamb 310. Further, the screw 346 is disposed through the aluminum head jamb 320 and within the second screw boss 532 to couple the aluminum head jamb 320 to the Z-shaped member 500 of the second aluminum side jamb 310.

Referring to FIGS. 4, 13, 14, 24, the aluminum sill assembly 330 is coupled to and extends between the bottom end 436 of the first aluminum side jamb 300 and the bottom end 536 of the second aluminum side jamb 310. The aluminum sill assembly 330 includes a threshold receiver 700 and a threshold member 702 each constructed of aluminum. The threshold receiver 700 is configured to receive the threshold member 702 therein.

Referring FIGS. 4 and 13, as discussed above the screw 348 is disposed through the threshold member 702 of the aluminum sill assembly 330 and within the first screw boss 430 to couple the aluminum sill assembly 330 to the Z-shaped member 400 of the first aluminum side jamb 300. Further, the screw 350 is disposed through the threshold member 702 of the aluminum sill assembly 330 and within the second screw boss 432 to couple the aluminum sill assembly 330 to the Z-shaped member 400 of the first aluminum side jamb 300.

Referring FIGS. 4 and 14, as discussed above the screw 352 is disposed through a threshold member 702 of the aluminum sill assembly 330 and within the first screw boss 530 to couple the aluminum sill assembly 330 to the Z-shaped member 500 of the second aluminum side jamb 310. Further, the screw 354 is disposed through the threshold member 702 of the aluminum sill assembly 330 and within the second screw boss 532 to couple the aluminum sill assembly 330 to the Z-shaped member 500 of the second aluminum side jamb 310.

Referring to FIGS. 4, 15 and 20, the door 210 is rotatably coupled to the first aluminum side jamb 300 utilizing the hinge members 220, 222, 224. Since the structure of the hinge members 220, 222, 224 are identical to one another, only the structure of the hinge member 220 will be described in greater detail below.

The hinge member 220 includes a ring portion 740, an attachment plate 742, an arm portion 744, and a post 746. The arm portion 744 is coupled to and between the ring portion 740 and the attachment plate 742. The post 746 extends through an aperture of the ring portion 740 and has a longitudinal length greater than the ring portion 740 such that the post 746 has first and second post portions extending past opposite ends of the ring portion 740.

During installation, the hinge member 220 is disposed in the cut-out portion 460 (shown in FIG. 4) of the arcuate-shaped hinge receiving portion 416 such that the first and second post portions of the post 746 are received in an aperture of the arcuate-shaped hinge receiving portion 416. Further, the screws 240, 242 extend through the attachment plate 742 and into the door 210 to couple the attachment plate 742 to the door 210.

Further, the hinge member 222 is disposed in the cut-out portion 462 (shown in FIG. 4) of the arcuate-shaped hinge receiving portion 416 such that the first and second post portions of a respective post of the hinge member 222 are received in an aperture of the arcuate-shaped hinge receiving portion 416. Further, the screws 244, 246 extend through an attachment plate of the hinge member 222 and into the door 210 to couple an attachment plate of the hinge member 222 to the door 210.

Further, the hinge member 224 is disposed in the cut-out portion 464 (shown in FIG. 4) of the arcuate-shaped hinge receiving portion 416 such that the first and second post portions of a respective post of the hinge member 224 are received in an aperture of the arcuate-shaped hinge receiving portion 416. Further, the screws 248, 250 extend through an attachment plate of the hinge member 224 and into the door 210 to couple an attachment plate of the hinge member 224 to the door 210.

The door system 20 described herein provides a substantial advantage over other door systems. In particular, the door system 20 encapsulates previously installed steel side jambs (without having to remove the previously installed steel side jambs) and is rust resistant. Further, the door system 20 has a door jamb assembly with first and second aluminum side jambs with first and second screw bosses that are used to easily and securely couple the first and second aluminum side jambs to an aluminum head jamb and an aluminum sill assembly.

While the claimed invention has been described in detail in connection with only a limited number of embodiments, it should be readily understood that the invention is not limited to such disclosed embodiments. Rather, the claimed invention can be modified to incorporate any number of variations, alterations, substitutions or equivalent arrangements not heretofore described, but which are commensurate with the spirit and scope of the invention. Additionally, while various embodiments of the claimed invention have been described, it is to be understood that aspects of the invention may include only some of the described embodiments. Accordingly, the claimed invention is not to be seen as limited by the foregoing description.

What is claimed is:

1. A door system, comprising:
a door jamb assembly having first and second aluminum side jambs, an aluminum head jamb, an aluminum sill assembly, and first, second, third and fourth screws;
the first aluminum side jamb being sized and shaped to encapsulate a first portion of a previously installed first side jamb, the first aluminum side jamb having a top end, a bottom end, and a first screw boss extending from the top end to the bottom end thereof;
the second aluminum side jamb being sized and shaped to encapsulate a first portion of a previously installed second side jamb, the second aluminum side jamb having a top end, a bottom end, and a first screw boss extending from the top end to the bottom end thereof;
the aluminum head jamb extending between the top end of the first aluminum side jamb and the top end of the second aluminum side jamb;
the first screw being disposed through the aluminum head jamb and within the first screw boss of the first aluminum side jamb to couple the aluminum head jamb to the first aluminum side jamb;
the second screw being disposed through the aluminum head jamb and within the first screw boss of the second aluminum side jamb to couple the aluminum head jamb to the second aluminum side jamb;
the aluminum sill assembly extending between the bottom end of the first aluminum side jamb and the bottom end of the second aluminum side jamb;
the third screw being disposed through the aluminum sill assembly and within the first screw boss of the first aluminum side jamb to couple the aluminum sill assembly to the first aluminum side jamb;
the fourth screw being disposed through the aluminum sill assembly and within the first screw boss of the second aluminum side jamb to couple the aluminum sill assembly to the second aluminum side jamb; and
a door rotatably coupled to the first aluminum side jamb.

2. The door system of claim 1, wherein:
the first screw boss of the first aluminum side jamb extending along an entire longitudinal length of the first aluminum side jamb.

3. The door system of claim 2, wherein:
the first screw boss of the second aluminum side jamb extending along an entire longitudinal length of the second aluminum side jamb.

4. The door system of claim 1, wherein:
the first aluminum side jamb having a second screw boss extending from the top end to the bottom end thereof; and
the second aluminum side jamb having a second screw boss extending from the top end to the bottom end thereof.

5. The door system of claim 4, further comprising:
a fifth screw being disposed through the aluminum head jamb and within the second screw boss of the first aluminum side jamb to couple the aluminum head jamb to the first aluminum side jamb; and
a sixth screw being disposed through the aluminum head jamb and within the second screw boss of the second aluminum side jamb to couple the aluminum head jamb to the second aluminum side jamb.

6. The door system of claim 5, further comprising:
a seventh screw being disposed through the aluminum sill assembly and within the second screw boss of the first aluminum side jamb to couple the aluminum sill assembly to the first aluminum side jamb; and
an eighth screw being disposed through the aluminum sill assembly and within the second screw boss of the second aluminum side jamb to couple the aluminum sill assembly to the second aluminum side jamb.

7. The door system of claim 1, further comprising:
a first aluminum trim portion that is coupled to the first aluminum side jamb and being sized and shaped to encapsulate a second portion of the previously installed first side jamb; and
a second aluminum trim portion that is coupled to the second aluminum side jamb and being sized and shaped to encapsulate a second portion of the previously installed second side jamb.

8. The door system of claim 1, wherein:
the first aluminum side jamb having a first Z-shaped member having the top end and the bottom end and a first arcuate-shaped hinge receiving portion.

9. The door system of claim 8, further comprising:
a first hinge member having a post being rotatably received in the first arcuate-shaped hinge receiving portion of the first Z-shaped member of the first aluminum side jamb and being further coupled to the door to rotatably couple the door to the first Z-shaped member.

10. The door system of claim 8, wherein:
the first Z-shaped member further includes first, second, and third walls and first, second, third and fourth tab portions;
the first and second tab portions extending from the first wall in a first direction;
the first arcuate-shaped hinge receiving portion being coupled between the first and second walls, the first and second walls extending perpendicular to one another;
the first and second screw bosses of the first Z-shaped member being coupled to the second wall;
the third wall extending from the second wall in a second direction perpendicular to the second wall; and
the third and fourth tab portions extending from the third wall in the first direction.

11. The door system of claim 10, wherein:
the aluminum head jamb further includes a weather-strip member, the weather-strip member being coupled to the third side wall and extending toward the door and contacting the door when the door is in a closed operational position.

12. The door system of claim 1, wherein:
the aluminum head jamb having a rain guard member to direct rain away from the door.
